(19) United States
(12) Patent Application Publication
(10) Pub. No.: US 2018/0335598 A1
(43) Pub. Date: Nov. 22, 2018

(54) LENS DRIVING APPARATUS AND ADJUSTMENT METHOD THEREOF

(71) Applicant: TOPRAY MEMS INC., Hsinchu City (TW)

(72) Inventors: Tzu-Kuang Fang, Hsinchu City (TW); Chin-Sung Liu, Hsinchu City (TW); Shin-Ter Tsai, Hsinchu City (TW); Yung-Fu Huang, Hsinchu City (TW); Yueh-Lin Hsieh, Hsinchu City (TW)

(21) Appl. No.: 15/642,515

(22) Filed: Jul. 6, 2017

(30) Foreign Application Priority Data
May 19, 2017 (TW) 106116595

(51) Int. Cl. G02B 7/02

(52) U.S. Cl. CPC G02B 7/02

(57) ABSTRACT

A adjustment method for lens driving apparatus is provided, comprising: (a) assembling a lens in a voice coil motor (VCM), with optical axis tilting towards a normal of VCM bottom surface and forming a tilt angle; forming at least three pillars at VCM bottom surface; (b) performing processing on the pillars according to the tilting direction and tilt angle, after processing, at least pillar having a length different from remaining pillars, each pillar having a bottom at first datum plane, and the optical axis perpendicular to first datum plane; (c) an image sensor having an engaging surface engaged to the pillar bottoms and located at the first datum plane, so that the lens optical axis s perpendicular to the engaging surface of the image sensor, resulting in the optical axis of the lens overlapping an axis of the image sensor to achieve 0° tilt angle.

### CROSS-REFERENCE TO RELATED APPLICATION

The present application is based on, and claims priority form, Taiwan Patent Application No. 106116595, filed May 19, 2017, the disclosure of which is hereby incorporated by reference herein in its entirety.

### TECHNICAL FIELD

The technical field generally relates to a lens driving apparatus and adjustment method thereof, and in particular, to a lens driving apparatus with 0° tilt angle between optical axis of the lens and the axis of the image sensor and adjustment method thereof.

### BACKGROUND

As the camera function of mobile phone becomes ubiquitous, the demands on the imaging quality of mobile phone camera are getting higher and higher. The improvement of camera imaging quality depends on the design of the design and manufacturing process, wherein the angular offset (i.e., the tilt) of the optical axis of the lens and the axis of the image sensor becomes one of the key factors influencing the imaging quality.

Refer to FIGS. 1-3. FIG. 1 shows a schematic view of a conventional lens driving apparatus, FIG. 2 shows a dissected view of a conventional lens driving apparatus, and FIG. 3 shows a side view of a conventional lens driving apparatus. A conventional lens driving apparatus comprises a voice coil motor (VCM) 1, a lens 2, and an image sensor 3. The voice coil motor 1 comprises an outer cover 1A, an upper elastic element 1B, a plurality of magnets 1C, a coil 1D, a base 1E, a lower elastic element 1F, and a lower cover 1G. The lens 2 is provided in the base 1E of the voice coil motor 1. The image sensor 3 is engaged to the bottom surface of the lower cover 1G.

However, the components of the voice coil motor 1 have a tolerance problem, and the tolerance stack resulted from the assembly of all the components will lead to an optical axis 2A of the lens 2 not perpendicular to the bottom surface of the lower cover 1G. Therefore, the optical axis 2A of the lens 2 cannot be overlapped with the axis 3A of the image sensor 3 and results in a tilt angle θ 1 after the image sensor 3 is engaged to the lower cover 1G, as shown in FIG. 3, and the imaging quality of the image sensor 3 is affected.

To improve the aforementioned problem, an approach is to improve the component precision and reduce the component tolerance as well as tolerance stack after assembly to achieve reducing the tilt angle θ 1 and improving the imaging quality of the image sensor 3.

Nevertheless, although the contemporary precision tool machines and manufacturing technology can produce high-precision products, it is still difficult to achieve the manufacturing goal of the accuracy of a certain scale in the manufacture of a large number of parts without tolerance deviation. The reason is that many other external factors will affect the accuracy of production, such as, the vibration of the machine, the material variation, the tool abrasion, the mold size deviation, the temperature change, the residual stress of the components, and so on. Therefore, the components of the voice coil motor 1 will always have non-zero tolerance, and non-zero tolerance stack after assembly. In other words, the possibility to achieve 0° tilt angle between optical axis of the lens and the axis of the image sensor by increasing the precision of the components is at best minimal with very limited result. Moreover, this approach requires continuous manufacturing technology breakthrough, which is extremely time-consuming if at all, not to mention the incurred cost, which is not in line with economic efficiency.

### SUMMARY

The primary object of the present invention is to provide an adjustment method for lens driving apparatus, so that the optical axis of the lens is overlapped with the axis of the image sensor to achieve 0° tilt angle between optical axis of the lens and the axis of the image sensor, leading to high imagining quality of the image sensor. The method is simple, efficiency and inexpensive.

Another object of the present invention is to provide a lens driving apparatus, so that the optical axis of the lens is overlapped with the axis of the image sensor to achieve 0° tilt angle between optical axis of the lens and the axis of the image sensor, leading to high imagining quality of the image sensor. The apparatus is simple in structure, and inexpensive in cost.

To achieve the aforementioned object, the present invention provides an adjustment method for lens driving apparatus, comprising:

(a) assembling a lens in a voice coil motor (VCM), an optical axis of the lens tilting towards a normal of a bottom surface of the VCM and forming a tilt angle with the normal of the bottom surface of the VCM; forming at least three pillars at the bottom surface of the VCM.

(b) performing processing on the pillars according to the tilting direction of the optical axis of the lens with respect to the normal of VCM bottom surface and the tilt angle, wherein, after processing, at least one of the pillars having a length different from the remaining pillars, and each of the pillars having a bottom located at a first datum plane, and the optical axis of the lens perpendicular to the first datum plane.

(c) an image sensor having an engaging surface engaged to the bottoms of the pillars and located at the first datum plane, so that the optical axis of the lens perpendicular to the engaging surface of the image sensor, resulting in the optical axis of the lens overlapping an axis of the image sensor.

Preferably, in step (a), the pillars are disposed around the bottom surface of VCM at locations corresponding to at least three positions at different sides of the lens.

Preferably, in step (a), the bottom surface of VCM is rectangular, and four pillars are disposed at four corners of the VCM bottom surface so that the pillars are disposed around the bottom surface of VCM at locations corresponding to four positions at different sides of the lens.

Preferably, in step (a), the pillars are integrated monolithically to the bottom surface of the VCM.

Preferably, in step (a), the pillars are disposed fixedly at the bottom surface of the VCM.

Preferably, in step (a), the pillars are detachably disposed at the bottom surface of the VCM.

Preferably, in step (a), the pillars have the same length and with bottoms located at a second datum plane.

Preferably, in step (b), the processing on the pillars is a deformation processing or removal processing to reduce protrusion amount of the pillars.

Preferably, the deformation processing is a hot pressing process.

Preferably, the removal processing is a cutting or grinding process.

Preferably, in step (b), a sensor is used to obtain a tilt direction and tilt angle information is obtained by sensing the tilt direction and tilt angle between the optical axis of the lens and the normal of the VCM bottom surface, the tilt direction and tilt angle information is passed to a control unit, the control unit computes an appropriate protrusion amount for each of the pillars according to tilt direction and tilt angle information to control a deformation processing facility or a removal processing facility to perform deformation processing or removal processing on the pillars to reduce the protrusion amount of each of the pillars until reaching the appropriate protrusion amount for each of the pillars.

Preferably, in step (b), the assembly of the lens and the VCM is placed on a platform surface, with the bottom of the pillars against the platform surface and the sensor is disposed at the platform.

The advantage of the present invention is that, regardless of the tolerances of the VCM components and the stack tolerance after assembly, as the adjustment method of the lens driving apparatus of the present invention, by forming the pillars on the VCM bottom surface and performing special treatment on the pillars to obtain specific configuration based on the individual difference of the lens driving apparatus, is able to make the optical axis of the lens perpendicular to the engaging surface of the image sensor so that the optical axis of the lens and the axis of the image sensor can be overlapped to achieve 0° tilt angle between the optical axis of the lens and the axis of the image sensor and improve the subsequent problem caused by the tilt of the optical axis of the lens due to the tolerance of the VCM components, thereby, improving the imaging quality of the image sensor and the yield rate of lens drive apparatus. The adjustment method is very simple, efficient, and low cost.

To achieve the aforementioned object, the present invention provides a lens driving apparatus, comprising: a voice coil motor (VCM), a lens, at least three pillars and an image sensor.

The VCM has a bottom surface, and the bottom surface has a normal.

The lens is disposed at the VCM and has an optical axis, with the optical axis tilting towards a normal of a bottom surface of the VCM and forming a tilt angle with the normal of the bottom surface of the VCM.

The pillars are disposed at the bottom surface of the VCM, with at least one of the pillars having a length different from the remaining pillars, and each of the pillars having a bottom located at a first datum plane, and the optical axis of the lens perpendicular to the first datum plane.

The image sensor has an engaging surface and an axis, with the engaging surface engaged to the bottoms of the pillars and located at the first datum plane, so that the optical axis of the lens perpendicular to the engaging surface of the image sensor, resulting in the optical axis of the lens overlapping the axis of the image sensor.

Preferably, the pillars are disposed around the bottom surface of VCM at locations corresponding to at least three positions at different sides of the lens.

Preferably, the bottom surface of VCM is rectangular, and four pillars are disposed at four corners of the VCM bottom surface so that the pillars are disposed around the bottom surface of VCM at locations corresponding to four positions at different sides of the lens.

Preferably, the pillars are integrated monolithically to the bottom surface of the VCM.

Preferably, the pillars are disposed fixedly at the bottom surface of the VCM.

Preferably, the pillars are detachably disposed at the bottom surface of the VCM.

The advantage of the present invention is that, regardless of the tolerances of the VCM components and the stack tolerance after assembly, as the lens driving apparatus of the present invention, with the pillars on the VCM bottom surface and the pillars to be of specific configuration based on the individual difference of the lens driving apparatus, is able to make the optical axis of the lens perpendicular to the engaging surface of the image sensor so that the optical axis of the lens and the axis of the image sensor can be overlapped to achieve 0° tilt angle between the optical axis of the lens and the axis of the image sensor and improve the subsequent problem caused by the tilt of the optical axis of the lens due to the tolerance of the VCM components, thereby, improving the imaging quality of the image sensor and the yield rate of lens drive apparatus. The adjustment method is very simple, efficient, and low cost.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a conventional lens driving apparatus;

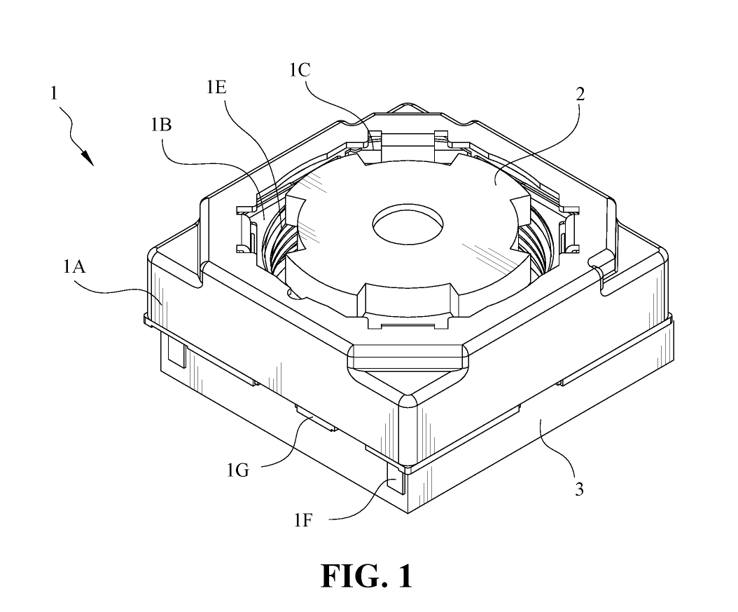

FIG. 2 shows a dissected view of a conventional lens driving apparatus;

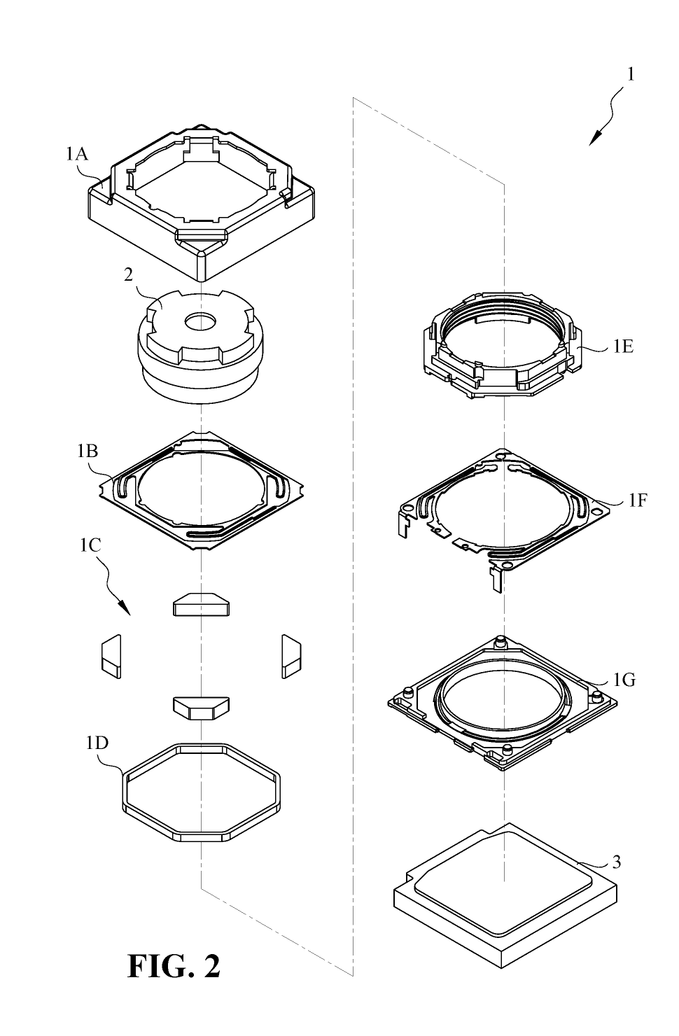

FIG. 3 shows a side view of a conventional lens driving apparatus.

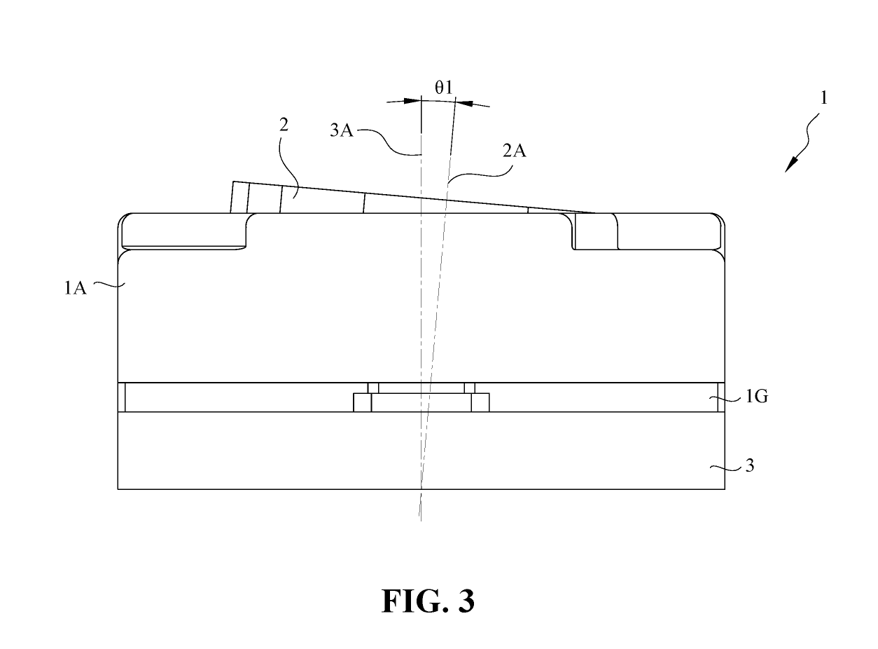

FIG. 4 shows a flowchart of the adjustment method for lens driving apparatus according to the present invention;

FIG. 5 shows a schematic view of the preparation step of the adjustment method for lens driving apparatus according to the present invention;

FIG. 6 shows a schematic view of the adjustment step of the adjustment method for lens driving apparatus according to the present invention, with the assembly of lens and VCM placed on a platform;

FIG. 7 shows a schematic view of the adjustment step of the adjustment method for lens driving apparatus according to the present invention, with the pillars after processed;

FIG. 8 shows a schematic view of the engagement step of the adjustment method for lens driving apparatus according to the present invention;

FIG. 9 shows a schematic view of the lens driving apparatus according to the present invention;

FIG. 10 shows a dissected view of the lens driving apparatus according to the present invention;

FIG. 11 shows a side view of the lens driving apparatus according to the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

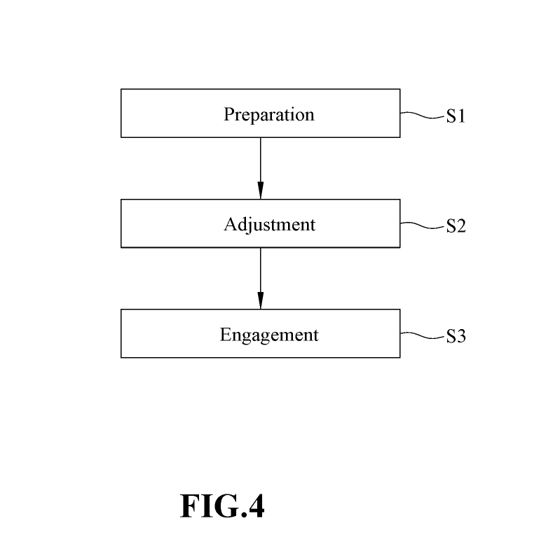

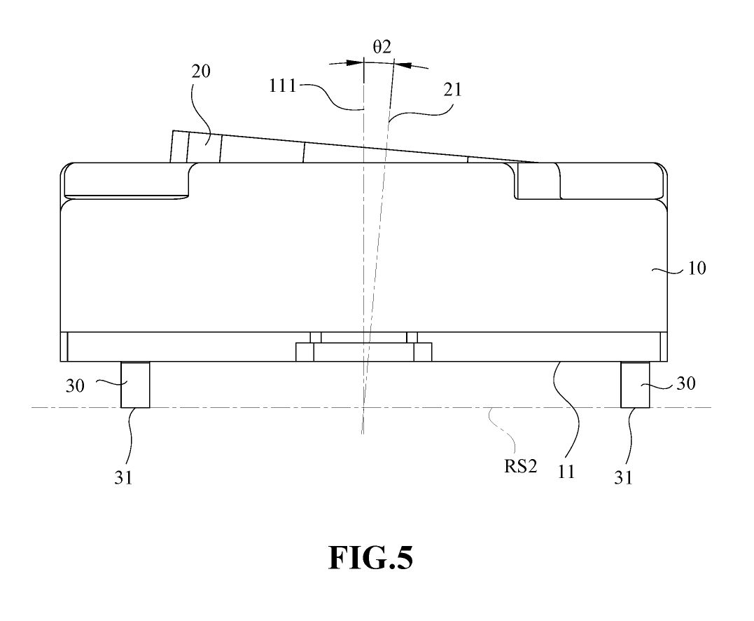

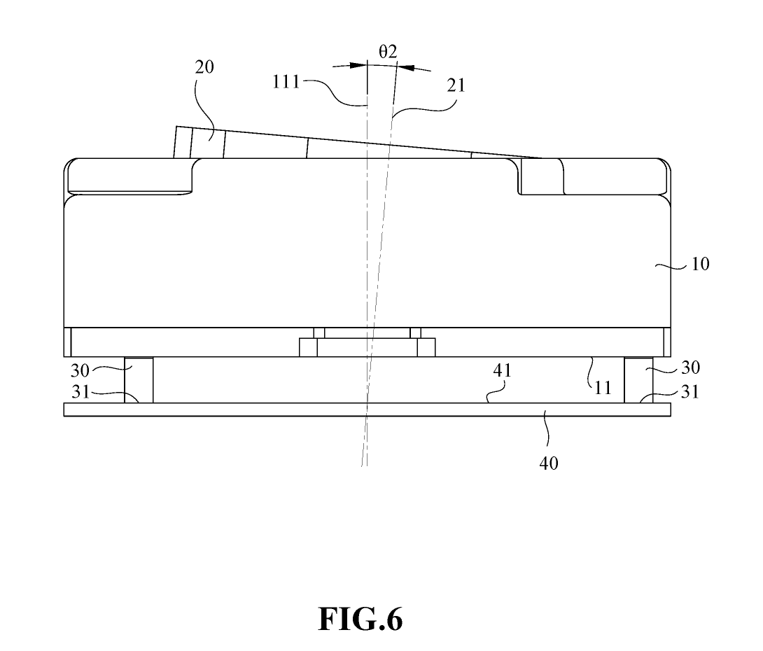

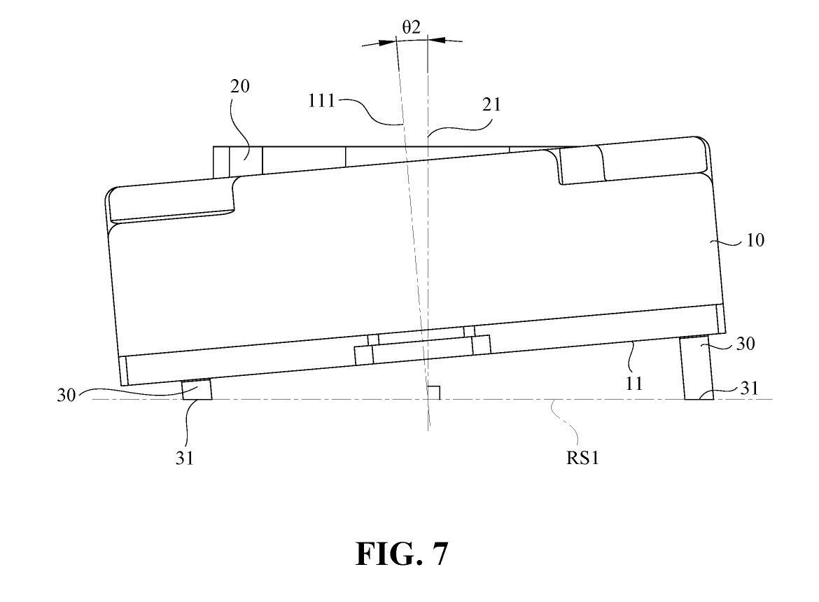

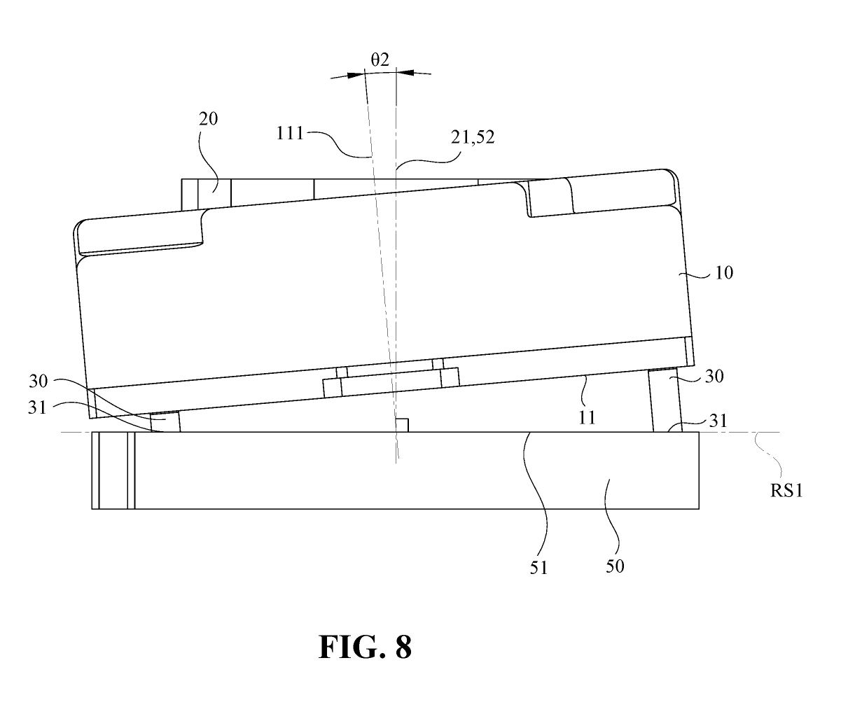

Refer to FIGS. 4-8. FIG. 4 shows a flowchart of the adjustment method for lens driving apparatus according to the present invention; FIG. 5 shows a schematic view of the preparation step of the adjustment method for lens driving apparatus according to the present invention; FIG. 6 shows a schematic view of the adjustment step of the adjustment method for lens driving apparatus according to the present invention, with the assembly of lens and VCM placed on a platform; FIG. 7 shows a schematic view of the adjustment step of the adjustment method for lens driving apparatus according to the present invention, with the pillars after processed; and FIG. 8 shows a schematic view of the engagement step of the adjustment method for lens driving apparatus according to the present invention. The present invention provides an adjustment method for lens driving apparatus, comprising the following steps of:

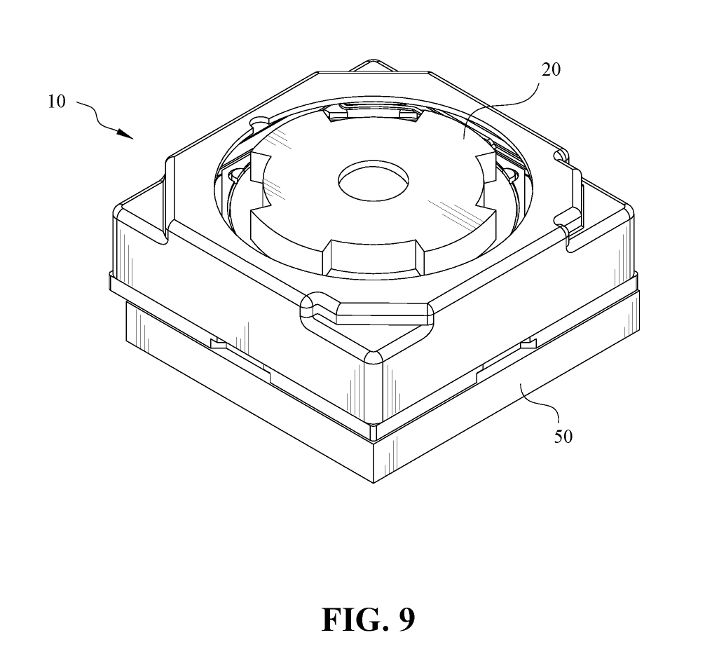

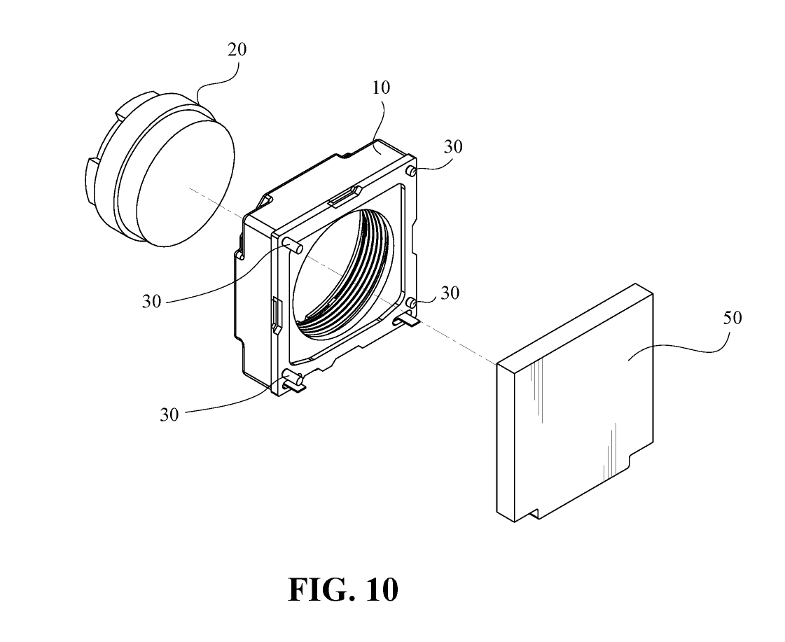

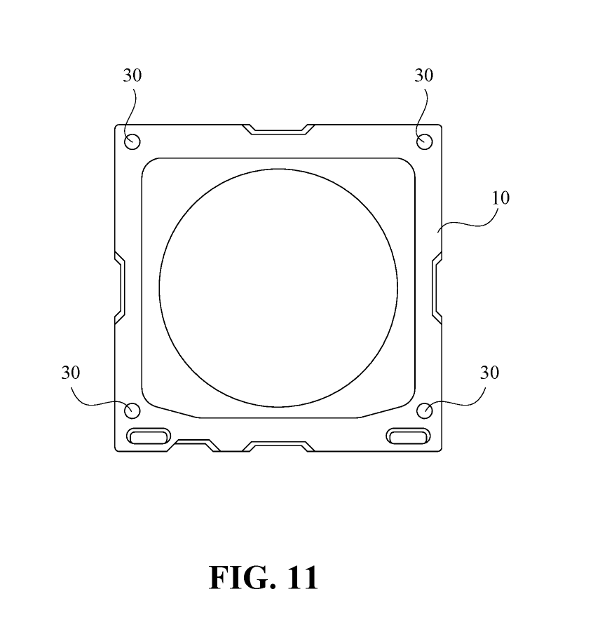

Preparation step S1: assembling a lens 20 in a voice coil motor (VCM) 10, an optical axis 21 of the lens 20 tilting towards a normal 111 of a bottom surface 11 of the VCM 10 and forming a tilt angle θ 2 with the normal 111 of the bottom surface 11 of the VCM 10; forming at least three pillars 30 at the bottom surface 11 of the VCM 10, as shown in FIG. 5. Specifically, the VCM 10 comprises an outer cover, an upper elastic element, four magnets, a coil, a base, a lower elastic element, and a lower cover, as shown in FIG. 9. Because the VCM 10 has a widely known structure, the details of each component and related linkage will be not described here. A lower surface of the lower cover is defined as the bottom surface 11 of the VCM 10, and the lens 20 is housed inside an accommodation grove formed by the components of the VCM 10. However, as the components of the VCM 10 have tolerance and the resulted assembly has tolerance stack, the optical axis 21 of the lens 20 is unable to be perpendicular to the bottom surface 11 of the VCM 10. Therefore, the optical axis 21 of the lens 20 will not overlap the normal 111 of the bottom surface 11 of the VCM and forms a tilt angle θ 2 with the normal 111 of the bottom surface 11 of the VCM 10. Wherein, the pillars 30 are disposed around the bottom surface 11 of VCM 10 at locations corresponding to at least three positions at different sides of the lens 20 to provide a more uniform support with at least three points. In the present embodiment, the bottom surface 11 of VCM 10 is rectangular, and four pillars 30 are disposed at four corners of the VCM bottom surface 11, as shown in FIG. 10 and FIG. 11. As such, the pillars 30 are disposed around the bottom surface 11 of VCM 10 at locations corresponding to four positions at different sides of the lens 20 to provide a more uniform support with four points. Preferably, the pillars 30 are integrated monolithically to the bottom surface 11 of the VCM 10. Specifically, the pillars 30 can be directly formed monolithically at the bottom surface 11 of the VCM 10 by using a mold to manufacturing the lower cover of the VCM. In other embodiments, the pillars 30 are disposed fixedly at the bottom surface 11 of the VCM 10. Specifically, the pillars 30 and the lower cover of the VCM 10 are manufactured separately, and then a fixation means is used to fix the pillars 30 to the bottom surface 11 of the VCM 10. The fixation means can be soldering or glue, but not limited to the above. Any means able to fix the pillars 30 to the bottom surface 11 of the VCM 10 are also within the scope of the present invention. In yet other embodiments, the pillars 30 are detachably disposed at the bottom surface 11 of the VCM 11. Specifically, the pillars 30 and the lower cover of the VCM 10 are manufactured separately, and then a detachable means, such as screws or plug, is used to attach the pillars 30 to the bottom surface 11 of the VCM 10. The detachable means can be screws or insertion hole (not shown), but not limited to the above. Any means able to detachably attach the pillars 30 to the bottom surface 11 of the VCM 10 are also within the scope of the present invention. Preferably, the pillars 30 have the same length and the bottoms 31 are all at a second datum plane RS2.

Adjustment step S2: performing processing on the pillars 30 according to the tilting direction of the optical axis 21 of the lens 20 with respect to the normal 111 of VCM bottom surface 11 and the tilt angle θ 2, as shown in FIG. 6; wherein, after processing, at least one of the pillars 30 having a length different from the remaining pillars 30, and each of the pillars 30 having a bottom 31 located at a first datum plane RS1, and the optical axis 21 of the lens 20 perpendicular to the first datum plane RS1, a shown in FIG. 7. More specifically, a sensor (not shown) is used to obtain a tilt direction and tilt angle information is obtained by sensing the tilt direction and tilt angle θ 2 between the optical axis 21 of the lens 20 and the normal 111 of the VCM bottom surface 11, the tilt direction and tilt angle information is passed to a control unit (not shown), the control unit computes an appropriate protrusion amount for each of the pillars 30 according to tilt direction and tilt angle information to control a deformation processing facility (not shown) or a removal processing facility (not shown) to perform deformation processing or removal processing on the pillars to reduce the protrusion amount of each of the pillars 30 until reaching the appropriate protrusion amount for each of the pillars 30. After processing, at least one of the pillars 30 has a length different from the remaining pillars 30, and each of the pillars 30 have a bottom 31 located at a first datum plane RS1, and the optical axis 21 of the lens 20 is perpendicular to the first datum plane RS1. Preferably, the assembly of the lens 20 and the VCM 10 is placed on a surface 41 of a platform surface 40, with the bottom 31 of the pillars 30 against the platform surface 41 and the sensor is disposed at the platform 40 to execute the above task, as shown in FIG. 6. It should be noted that because the tilt direction and the tilt angle θ 2 between the optical axis 21 of the lens 20 and the normal 111 of the VCM bottom surface 11 are different for every lens driving apparatus, the protrusion amount of each pillar 30 of each lens driving apparatus must be individually adjusted according to the tilt direction and the tilt angle θ 2 between the optical axis 21 of the lens 20 and the normal 111 of the VCM bottom surface 11, which is the appropriate protrusion amount of each pillar 30. Wherein, processing on the pillars 30 is a deformation processing or removal processing to reduce protrusion amount of the pillars. The deformation processing is a hot pressing process, and the related deformation processing facility is heating equipment. The removal processing is a cutting or grinding process, and the related removal processing facility is a cutting device or a grinding device. However, other deformation processing and related facility as well as other removal processing and related facility is also within the scope of the present invention.

Engagement step S3: an image sensor 50 having an engaging surface 51 engaged to the bottoms 31 of the pillars 30 and located at the first datum plane RS1, so that the optical axis 21 of the lens 20 being perpendicular to the engaging surface 51 of the image sensor 50, resulting in the optical axis 21 of the lens 20 overlapping an axis 52 of the image sensor 50, as shown in FIG. 8.

As such, regardless of the tolerances of the VCM 10 components and the stack tolerance after assembly, as the adjustment method of the lens driving apparatus of the present invention, by forming the pillars on the VCM bottom surface 11 and performing special treatment on the pillars 30 to obtain specific configuration based on the individual difference of the lens driving apparatus, is able to make the optical axis 21 of the lens 20 perpendicular to the engaging surface 51 of the image sensor 50 so that the optical axis 21 of the lens 20 and the axis 52 of the image sensor 50 can be overlapped to achieve 0° tilt angle between the optical axis 21 of the lens 20 and the axis 52 of the image sensor 50 and improve the subsequent problem caused by the tilt of the optical axis 21 of the lens 20 due to the tolerance of the VCM 10 components, thereby, improving the imaging quality of the image sensor 50 and the yield rate of lens drive apparatus. The adjustment method is very simple, efficient, and low cost.

Refer to FIGS. 8-11. FIG. 8 shows a schematic view of the engagement step of the adjustment method for lens driving apparatus according to the present invention; FIG. 9 shows a schematic view of the lens driving apparatus according to the present invention; FIG. 10 shows a dissected view of the lens driving apparatus according to the present invention; and FIG. 11 shows a side view of the lens driving apparatus according to the present invention. The present invention provides a lens driving apparatus, comprising: a voice coil motor (VCM) 10, a lens 20, at least three pillars 30 and an image sensor 50.

The VCM 10 has a bottom surface 11, and the bottom surface 11 has a normal 111. Specifically, the VCM 10 comprises an outer cover, an upper elastic element, four magnets, a coil, a base, a lower elastic element, and a lower cover, as shown in FIG. 9. Because the VCM 10 has a widely known structure, the details of each component and related linkage will be not described here. A lower surface of the lower cover is defined as the bottom surface 11 of the VCM 10.

The lens 20 is disposed at the VCM 10 and has an optical axis 21, with the optical axis 21 tilting towards the normal 111 of the bottom surface 11 of the VCM 10 and forming a tilt angle θ 2 with the normal 111 of the bottom surface 11 of the VCMM 10. Specifically, the lens 20 is housed inside an accommodation grove formed by the components of the VCM 10. However, as the components of the VCM 10 have tolerance and the resulted assembly has tolerance stack, the optical axis 21 of the lens 20 is unable to be perpendicular to the bottom surface 11 of the VCM 10. Therefore, the optical axis 21 of the lens 20 will not overlap the normal 111 of the bottom surface 11 of the VCM and forms a tilt angle θ 2 with the normal 111 of the bottom surface 11 of the VCM 10.

The pillars 30 are disposed at the bottom surface 11 of the VCM 10, with at least one of the pillars 30 having a length different from the remaining pillars 30, and each of the pillars 30 having a bottom 31 located at a first datum plane RS1, and the optical axis 21 of the lens 20 perpendicular to the first datum plane RS1. the pillars 30 are disposed around the bottom surface 11 of VCM 10 at locations corresponding to at least three positions at different sides of the lens 20 to provide a more uniform support with at least three points. In the present embodiment, the bottom surface 11 of VCM 10 is rectangular, and four pillars 30 are disposed at four corners of the VCM bottom surface 11, as shown in FIG. 10 and FIG. 11. As such, the pillars 30 are disposed around the bottom surface 11 of VCM 10 at locations corresponding to four positions at different sides of the lens 20 to provide a more uniform support with four points. Preferably, the pillars 30 are integrated monolithically to the bottom surface 11 of the VCM 10. Specifically, the pillars 30 can be directly formed monolithically at the bottom surface 11 of the VCM 10 by using a mold to manufacturing the lower cover of the VCM. In other embodiments, the pillars 30 are disposed fixedly at the bottom surface 11 of the VCM 10. Specifically, the pillars 30 and the lower cover of the VCM 10 are manufactured separately, and then a fixation means is used to fix the pillars 30 to the bottom surface 11 of the VCM 10. The fixation means can be soldering or glue, but not limited to the above. Any means able to fix the pillars 30 to the bottom surface 11 of the VCM 10 are also within the scope of the present invention. In yet other embodiments, the pillars 30 are detachably disposed at the bottom surface 11 of the VCM 11. Specifically, the pillars 30 and the lower cover of the VCM 10 are manufactured separately, and then a detachable means, such as screws or plug, is used to attach the pillars 30 to the bottom surface 11 of the VCM 10. The detachable means can be screws or insertion hole (not shown), but not limited to the above. Any means able to detachably attach the pillars 30 to the bottom surface 11 of the VCM 10 are also within the scope of the present invention. It should be noted that because the tilt direction and the tilt angle θ 2 between the optical axis 21 of the lens 20 and the normal 111 of the VCM bottom surface 11 are different for every lens driving apparatus, the protrusion amount of each pillar 30 of each lens driving apparatus must be individually adjusted according to the tilt direction and the tilt angle θ 2 between the optical axis 21 of the lens 20 and the normal 111 of the VCM bottom surface 11.

The image sensor 50 has an engaging surface 51 and an axis 52, with the engaging surface 51 engaged to the bottoms 31 of the pillars 30 and located at the first datum plane RS1, so that the optical axis 21 of the lens 20 perpendicular to the engaging surface 51 of the image sensor 50, resulting in the optical axis 21 of the lens 20 overlapping the axis 52 of the image sensor 50.

As such, regardless of the tolerances of the VCM 10 components and the stack tolerance after assembly, of the lens driving apparatus of the present invention, with the pillars on the VCM bottom surface 11 and the pillars 30 to have specific configuration based on the individual difference of the lens driving apparatus, is able to make the optical axis 21 of the lens 20 perpendicular to the engaging surface 51 of the image sensor 50 so that the optical axis 21 of the lens 20 and the axis 52 of the image sensor 50 can be overlapped to achieve 0° tilt angle between the optical axis 21 of the lens 20 and the axis 52 of the image sensor 50 and improve the subsequent problem caused by the tilt of the optical axis 21 of the lens 20 due to the tolerance of the VCM 10 components, thereby, improving the imaging quality of the image sensor 50 and the yield rate of lens drive apparatus. The lens driving apparatus is very simple in structure, and low in cost.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An adjustment method for lens driving apparatus, comprising the steps of:
(a) assembling a lens in a voice coil motor (VCM), an optical axis of the lens tilting towards a normal of a bottom surface of the VCM and forming a tilt angle with the normal of the bottom surface of the VCM; forming at least three pillars at the bottom surface of the VCM;
(b) performing processing on the pillars according to the tilting direction of the optical axis of the lens with respect to the normal of VCM bottom surface and the tilt angle, wherein, after processing, at least one of the pillars having a length different from the remaining pillars, and each of the pillars having a bottom located at a first datum plane, and the optical axis of the lens perpendicular to the first datum plane;
(c) an image sensor having an engaging surface engaged to the bottoms of the pillars and located at the first datum plane, so that the optical axis of the lens perpendicular to the engaging surface of the image sensor, resulting in the optical axis of the lens overlapping an axis of the image sensor.

2. The adjustment method for lens driving apparatus as claimed in claim 1, wherein in step (a), the pillars are disposed around the bottom surface of VCM at locations corresponding to at least three positions at different sides of the lens.

3. The adjustment method for lens driving apparatus as claimed in claim 2, wherein in step (a), the bottom surface of VCM is rectangular, and four pillars are disposed at four corners of the VCM bottom surface so that the pillars are disposed around the bottom surface of VCM at locations corresponding to four positions at different sides of the lens.

4. The adjustment method for lens driving apparatus as claimed in claim 1, wherein in step (a), the pillars are integrated monolithically to the bottom surface of the VCM.

5. The adjustment method for lens driving apparatus as claimed in claim 1, wherein in step (a), the pillars are disposed fixedly at the bottom surface of the VCM.

6. The adjustment method for lens driving apparatus as claimed in claim 1, wherein in step (a), the pillars are detachably disposed at the bottom surface of the VCM.

7. The adjustment method for lens driving apparatus as claimed in claim 1, wherein in step (a), the pillars have the same length and with bottoms located at a second datum plane.

8. The adjustment method for lens driving apparatus as claimed in claim 1, wherein in step (b), the processing on the pillars is a deformation processing or removal processing to reduce protrusion amount of the pillars.

9. The adjustment method for lens driving apparatus as claimed in claim 8, wherein the deformation processing is a hot pressing process.

10. The adjustment method for lens driving apparatus as claimed in claim 8, wherein the removal processing is a cutting or grinding process.

11. The adjustment method for lens driving apparatus as claimed in claim 8, wherein in step (b), a sensor is used to obtain a tilt direction and tilt angle information is obtained by sensing the tilt direction and tilt angle between the optical axis of the lens and the normal of the VCM bottom surface, the tilt direction and tilt angle information is passed to a control unit, the control unit computes an appropriate protrusion amount for each of the pillars according to tilt direction and tilt angle information to control a deformation processing facility or a removal processing facility to perform deformation processing or removal processing on the pillars to reduce the protrusion amount of each of the pillars until reaching the appropriate protrusion amount for each of the pillars.

12. The adjustment method for lens driving apparatus as claimed in claim 11, wherein in step (b), the assembly of the lens and the VCM is placed on a surface of a platform, with the bottom of the pillars against the platform surface and the sensor is disposed at the platform.

13. A lens driving apparatus, comprising: comprising:
a voice coil motor (VCM), having a bottom surface, and the bottom surface having a normal;
a lens, disposed at the VCM and having an optical axis, with the optical axis tilting towards a normal of a bottom surface of the VCM and forming a tilt angle with the normal of the bottom surface of the VCM;
at least three pillars, disposed at the bottom surface of the VCM, with at least one of the pillars having a length different from the remaining pillars, and each of the pillars having a bottom located at a first datum plane, and the optical axis of the lens perpendicular to the first datum plane and
an image sensor, having an engaging surface and an axis, with the engaging surface engaged to the bottoms of the pillars and located at the first datum plane, so that the optical axis of the lens perpendicular to the engaging surface of the image sensor, resulting in the optical axis of the lens overlapping the axis of the image sensor.

14. The lens driving apparatus as claimed in claim 13, wherein the pillars are disposed around the bottom surface of VCM at locations corresponding to at least three positions at different sides of the lens.

15. The lens driving apparatus as claimed in claim 14, wherein the bottom surface of VCM is rectangular, and four pillars are disposed at four corners of the VCM bottom surface so that the pillars are disposed around the bottom surface of VCM at locations corresponding to four positions at different sides of the lens.

16. The lens driving apparatus as claimed in claim 13, wherein the pillars are integrated monolithically to the bottom surface of the VCM.

17. The lens driving apparatus as claimed in claim 13, wherein the pillars are disposed fixedly at the bottom surface of the VCM.

18. The lens driving apparatus as claimed in claim 13, wherein the pillars are detachably disposed at the bottom surface of the VCM.
